(19) United States
(12) Patent Application Publication
(10) Pub. No.: US 2015/0317809 A1
(43) Pub. Date: Nov. 5, 2015

(54) SYSTEMS AND METHODS FOR EMERGENCY SITUATION COMMUNICATIONS

(71) Applicant: The Curators of the University of Missouri, Columbia, MO (US)

(72) Inventors: Sriram CHELLAPPAN, Rolla, MO (US); Srinivas THANDU, Rolla, MO (US); Patrick SULLIVAN, Saint James, MO (US); Levi MALOTT, Rolla, MO (US)

(21) Appl. No.: 14/697,954

(22) Filed: Apr. 28, 2015

Related U.S. Application Data
(60) Provisional application No. 61/988,356, filed on May 5, 2014.

(51) Int. Cl. G06T 11/20; G01C 21/26; H04W 4/02

(52) U.S. Cl. CPC G06T 11/206; H04W 4/02; G01C 21/265; H04W 4/22

(57) ABSTRACT

A system for enabling communications during an emergency situation is described. A system may be configured to generate graphical user interfaces including a map displaying a location and a status of the one or more users located at the scene of an emergency situation. The graphical user interfaces may be displayed on a user's portable computing device. The graphical user interfaces may be displayed at a computing device located at a dispatcher site.

### RELATED APPLICATION

This application claims the benefit of U.S. Provisional Application No. 61/988,356, filed on May 5, 2014, which is incorporated by reference in its entirety.

### GOVERNMENT SUPPORT

This invention was made with government support under contract No. 1205695 awarded by the National Science Foundation. The government has certain rights in the invention.

### TECHNICAL FIELD

This disclosure relates to systems and methods for emergency situation communications and more particularly to providing a system that may be used to enable communications during an emergency situation.

### BACKGROUND

Many recent incidents have occurred where people are caught in emergency situations, such as, for example, mass shootings, explosions, severe weather events, and industrial accidents. Emergency communication systems, such as, the 911 system in North America may be used by people caught in emergency situations to individually communicate with an emergency service. Emergency communication systems, such as, the system used by the National Weather Service to issue severe weather alerts may be used by an emergency service to broadcast information about an emergency situation.

Although these systems may be able to provide communications during some types of emergency situations, these emergency communications systems and other current emergency communications systems may not be able to adequately communicate with large numbers of people at or near locations of emergency situations. In particular, current emergency communication systems may not be able to adequately provide detailed information to a significant number of people involved in an emergency situation.

### SUMMARY

In general, this disclosure describes systems and techniques for emergency situation communications. In particular, this disclosure describes techniques for enabling communications during an emergency situation. In one example, an emergency communications system may include a device configured to communicate with an emergency service according to the techniques described herein. In some examples, the device may be a mobile device, for example, a smart phone. Further, an emergency communications system may include a device configured to process information received from one or more mobile devices according to techniques described herein. In some examples, the device may be a server located at an emergency service site. By enabling efficient communications between users of mobile devices and an emergency service, emergency responses may be coordinated more effectively, which may decrease the amount of damage caused during an emergency situation.

According to one example of the disclosure, a method for enabling emergency communications, comprises receiving location data from one or more users, receiving user status data from the one or more users, generating map data based on the received location data and the received user status data, and providing map data to the one or more users, wherein the map data enables a computing device to generate a graphical user interface including a map displaying a location and a status of the one or more users.

According to another example of the disclosure, a device for enabling emergency communications comprises one or more processors configured to receive location data from one or more users, receive user status data from the one or more users, generate map data based on the received location data and the received user status data, and provide map data to the one or more users, wherein the map data enables a computing device to generate a graphical user interface including a map displaying a location and a status of the one or more users.

According to another example of the disclosure, an apparatus for enabling emergency communications comprises means for receiving location data from one or more users, means for receiving user status data from the one or more users, means for generating map data based on the received location data and the received user status data, and means for providing map data to the one or more users, wherein the map data enables a computing device to generate a graphical user interface including a map displaying a location and a status of the one or more users.

According to another example of the disclosure, a non-transitory computer-readable storage medium comprises instructions stored thereon that upon execution cause one or more processors of a device to receive location data from one or more users, receive user status data from the one or more users, generate map data based on the received location data and the received user status data, and provide map data to the one or more users, wherein the map data enables a computing device to generate a graphical user interface including a map displaying a location and a status of the one or more users.

According to one example of the disclosure, a method for enabling emergency communications comprises receiving location data from one or more users, receiving user status data from the one or more users, and providing a graphical user interface including location data of the one or more users and status data of the one or more users.

According to another example of the disclosure, a device for enabling emergency communications comprises one or more processors configured to receive location data from one or more users, receive user status data from the one or more users, and provide a graphical user interface including location data of the one or more users and status data of the one or more users.

According to another example of the disclosure, an apparatus for enabling emergency communications comprises means for receiving location data from one or more users, means for receiving user status data from the one or more users, and means for providing a graphical user interface including location data of the one or more users and status data of the one or more users.

According to another example of the disclosure, a non-transitory computer-readable storage medium comprises instructions stored thereon that upon execution cause one or more processors of a device to receive location data from one or more users, receive user status data from the one or more users, and provide a graphical user interface including location data of the one or more users and status data of the one or more users.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that may implement one or more techniques of this disclosure.

FIG. 2 is a block diagram illustrating an example of a computing device that may implement one or more techniques of this disclosure.

FIG. 3 is a block diagram illustrating a detailed view of an example system that may implement one or more techniques of this disclosure.

FIG. 4 is a conceptual diagram illustrating an example of an application for emergency communications in accordance with one or more techniques of this disclosure.

FIG. 5 is an example of a graphical user interface that may be provided by a computing device to implement one or more techniques of this disclosure.

FIG. 6 is an example of a graphical user interface that may be provided by a computing device to implement one or more techniques of this disclosure.

FIG. 7 is an example of a graphical user interface that may be provided by a computing device to implement one or more techniques of this disclosure.

FIG. 8 is an example of a graphical user interface that may be provided by a computing device to implement one or more techniques of this disclosure.

FIG. 9 is an example of a graphical user interface that may be provided by a computing device to implement one or more techniques of this disclosure.

FIG. 10 is an example of a graphical user interface that may be provided by a computing device to implement one or more techniques of this disclosure.

FIGS. 11A-11B is an example of a graphical user interface that may be provided by a computing device to implement one or more techniques of this disclosure.

FIG. 12 is an example of a graphical user interface that may be provided by a computing device to implement one or more techniques of this disclosure.

FIG. 13 is a conceptual diagram illustrating one or more techniques of this disclosure.

### DETAILED DESCRIPTION

In general, this disclosure describes techniques for emergency situation communications. In particular, this disclosure describes techniques for enabling communications during an emergency situation. During an emergency situation, it is extremely important that responses and recoveries are coordinated effectively. For example, it is important that responders have information regarding the location of injured individuals before they arrive at a scene in order to effectively locate individuals in need of assistance. Unfortunately, existing systems for communicating during an emergency situation may not be as effective as possible in coordinating responses and recoveries. As a result, casualties may increase and financial losses due to an emergency situation may be increased. Further, ineffective emergency communications systems may erode public confidence in emergency communication systems, which may result in fewer people using a system during an emergency situation, making responses and recoveries more difficult to coordinate.

Emergency situations may originate from diverse sources. Sources of an emergency situation may be initially unknown to responders and may have diverse forms. For example, a responder may need more information in order to determine the source of a building fire. In order to maximize responsiveness to an emergency situation resulting from an unknown source it is important to enable people in an area of an emergency situation to better understand how and where help is needed. The techniques described herein may be used to collect and distribute key information to responders and citizens such that they may be better informed about an occurring emergency situation. In this manner, one does not have to wait for emergency service personnel to arrive to receive critical information or assistance.

The techniques described in this disclosure may be used to enable efficient communications during an emergency situation. Efficient communications may be used to effectively coordinate responses and recoveries. In one example, the techniques described herein may be implemented as part of a mobile device application. In one example, a mobile device application may be customizable for a variety of events resulting in an emergency situation, including, for example, a kidnapping, an on-going robbery, and larger scale emergencies like building collapses or explosions. In one example of this disclosure, civilians may communicate with government and law enforcement officers during an emergency situation using a mobile device, such as, for example, a smartphone. Further, in one example, agencies, such as, FEMA and local law enforcement agencies may coordinate responses using the techniques described herein. In one example of this disclosure, techniques described herein may be implemented as a graphical user interface for use by a dispatcher. In one example, the techniques describe herein may provide a graphical user interface on a server located at an emergency service site. In one example the graphical user interface may include an interactive map. The interactive map may enable a dispatcher, or similar emergency services personnel, to visualize victims and responders on the map. Further, the graphical user interface may enable a dispatcher to adaptively send and/or receive messages.

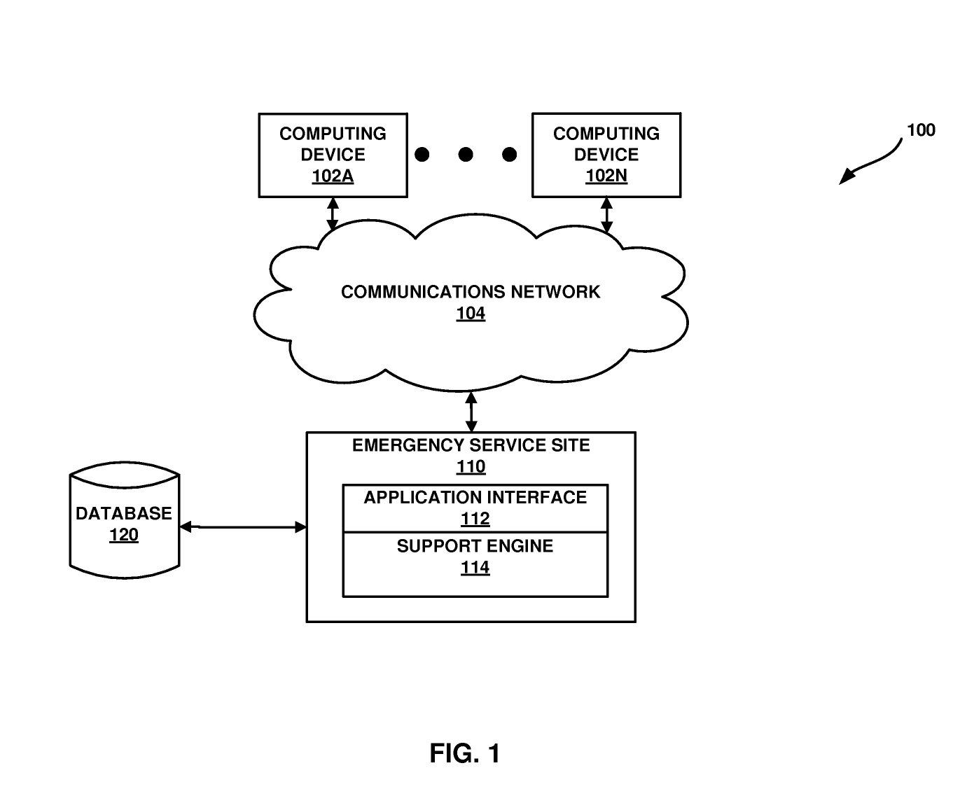

FIG. 1 is a block diagram illustrating an example system that may implement one or more techniques of this disclosure. System 100 may be configured to enable communications during an emergency situation in accordance with the techniques described herein. In the example illustrated in FIG. 1, system 100 includes one or more computing devices 102A-102N, communications network 104, and emergency service site 110. As illustrated in FIG. 1, emergency service site 110 includes application interface 112 and support engine 114. Further, emergency service site 110 may be connected to database 120. System 100 may include software modules operating on one or more servers. Software modules may be stored in a memory and executed by a processor. Servers may include one or more processors and a plurality of internal and/or external memory devices. Examples of memory devices include file servers, an FTP servers, network attached storage (NAS) devices, a local disk drive, or any other type of device or storage medium capable of storing data. Storage medium may include Blu-ray discs, DVDs, CD-ROMs, flash memory, or any other suitable digital storage media. When the techniques described herein are implemented partially in software, a device may store instructions for the software in a suitable, non-transitory computer-readable medium and execute the instructions in hardware using one or more processors.

System 100 represents an example of a system that may be configured to enable communications between computing devices, such as computing devices 102A-102N, and an emergency service site, such as, emergency service site 110. Computing devices 102A-102N may respectively include any device configured to transmit data to and receive data from communication network 104. For example, computing devices 102A-102N may be equipped for wired and/or wireless communications and may include desktop or laptop computers, mobile devices, smartphones, cellular telephones, set top boxes, and personal gaming devices.

Communications network 104 may comprise any combination of wireless and/or wired communication media. Communication network 104 may include routers, switches, base stations, or any other equipment that may be useful to facilitate communication between various devices and sites. Communication network 104 may form part of a packet-based network, such as a local area network, a wide-area network, or a global network such as the Internet. Communication network 104 may operate according to one or more communication protocols, such as, for example, a Global System Mobile Communications (GSM) standard, a code division multiple access (CDMA) standard, a 3rd Generation Partnership Project (3GPP) standard, an Internet Protocol (IP) standard, a Wireless Application Protocol (WAP) standard, and/or an IEEE standard, such as, one or more of the 802.11 standards, as well as various combinations thereof.

As illustrated in FIG. 1, emergency service site 110 is connected to communications network 104. Emergency service site 110 is configured to provide information to users of computing devices 102A-102N during an emergency situation. In one example, emergency service site 110 may be a server located at an emergency responder site. For example, emergency service site 110 may be a server located at a local police department, such as a city police station or a campus police station, a local fire department, an emergency medical service (EMS) site, a central emergency response site, such as an emergency call center, or a local office of a national emergency response site, such as, for example, a local FEMA office. In one example, emergency service site 110 may include a server whose IP address is set up by appropriate agencies such that computing devices 102A-102N have an immediate connection to the server for emergency purposes. It should be noted that the techniques described herein are generally applicable regardless of the physical location of emergency service site 110. In the example illustrated in FIG. 1, emergency service site 110 includes application interface 112 and support engine 114. Application interface 112 and support engine 114 may be implemented as any of a variety of suitable circuitry, such as one or more microprocessors, digital signal processors (DSPs), application specific integrated circuits (ASICs), field programmable gate arrays (FPGAs), discrete logic, software, software modules, hardware, firmware or any combinations thereof.

Application interface 112 may be configured to provide an interface between emergency service site 110 and one or more of computing devices 102A-102N. For example, as described in detail below, application interface 112 may provide one or more graphical user interfaces (GUIs) to computing devices 102A-102N. Users of a computing device may use the graphical user interfaces to communicate with emergency service site 110. It should be noted that providing a graphical user interface to a computing device may include providing data to a computing device such that a computing device may generate a graphical user interface. Support engine 114 may be configured to support the operations of emergency service site 110. For example, as described in detail below, support engine 114 may receive location data from one or more computing devices and generate map information based on received location data. As illustrated in FIG. 1, database 120 is connected to emergency service site 110. Database 120 may include any of the memory devices described above. Database 120 may store information associated with the operation of emergency service site 110. For example, database 120 may store user location and status information.

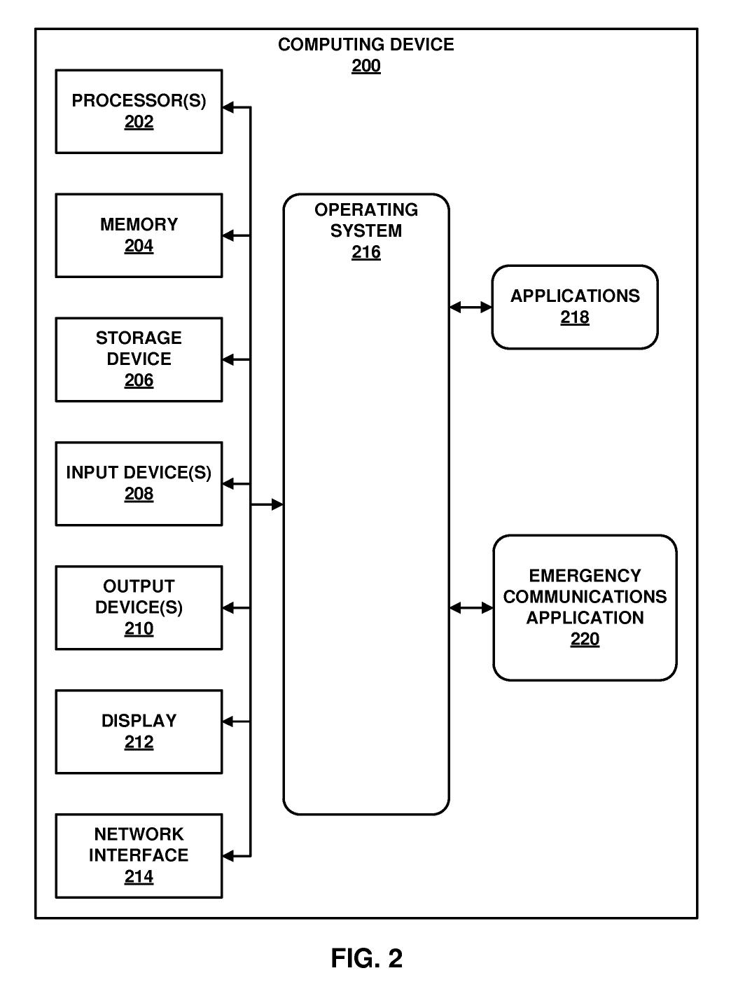

FIG. 2 is a block diagram illustrating an example of a computing device that may implement one or more techniques of this disclosure. Computing device 200 is an example of a computing device that may be configured to transmit data to and receive data from communication network 104 and execute one or more applications (e.g., emergency communications application 220). Computing device 200 may include or be part of a portable computing device (e.g., a mobile phone, netbook, laptop, personal data assistant (PDA), or tablet device) or a stationary computer (e.g., a desktop computer, or set-top box), or may be another computing device. Computing device 200 includes processor(s) 202, memory 204, storage device 206, input device(s) 208, output device(s) 210, display 212, and network interface 214. Each of processor(s) 202, memory 204, storage device 206, input device(s) 208, output device(s) 210, display 212, and network interface 214 may be interconnected (physically, communicatively, and/or operatively) for inter-component communications. Operating system 216, applications 218, and emergency communications application 220 may be executable by computing device 200. It should be noted that although example computing device 200 is illustrated as having distinct functional blocks, such an illustration is for descriptive purposes and does not limit computing device 200 to a particular hardware architecture. Functions of computing device 200 may be realized using any combination of hardware, firmware and/or software implementations.

Processor(s) 202 may be configured to implement functionality and/or process instructions for execution in computing device 200. Processor(s) 202 may be capable of retrieving and processing instructions, code, and/or data structures for implementing one or more of the techniques described herein. Instructions may be stored on a computer readable medium, such as memory 204 or storage device 206. Processor(s) 202 may include digital signal processors (DSPs), general purpose microprocessors, application specific integrated circuits (ASICs), field programmable logic arrays (FPGAs), or other equivalent integrated or discrete logic circuitry.

Memory 204 may be configured to store information that may be used by computing device 200 during operation. Memory 204 may be used to store program instructions for execution by processor(s) 202 and may be used by software or applications running on computing device 200 to temporarily store information during program execution. For example, memory 204 may store instructions associated with operating system 216, applications 218, and emergency communications application 220 or components thereof, and/or memory 204 may store information associated with the execution of operating system 216, applications 218, and emergency communications application 220. Memory 204 may be described as a non-transitory or tangible computer-readable storage medium. In some examples, memory 204 may provide temporary memory and/or long-term storage. In some examples, memory 204 or portions thereof may be described as volatile memory or non-volatile memory. Volatile memory may refer to memory that does not maintain stored contents when computing device 200 is powered down. Examples of volatile memories include random access memories (RAM), dynamic random access memories (DRAM), and static random access memories (SRAM). Non-volatile memory may refer to memory that does maintain stored contents when computing device 200 is powered down. Examples of such non-volatile storage elements may include magnetic hard discs, optical discs, floppy discs, flash memories, or forms of electrically programmable memories (EPROM) or electrically erasable and programmable (EEPROM) memories.

Storage device 206 represents memory of computing device that may be configured to store relatively larger amounts of information for relatively longer periods of time than memory 204. Similar to memory 204, storage device 206 may also include one or more non-transitory or tangible computer-readable storage media. Storage device 206 may be internal or external memory and in some examples may include volatile and/or non-volatile storage elements.

Input device(s) 208 may be configured to receive input from a user operating computing device 200. Input from a user may be generated as part of a user running one or more software applications, such as applications 218 and/or emergency communications application 220. Input device(s) 208 may include a touch-sensitive screen, track pad, track point, mouse, a keyboard, a microphone, video camera, or any other type of device configured to receive input from a user. In one example, input device(s) 208 may generate one or more signals that may be provided as information to components of computing device 200 (e.g., processor 202, or operating system 216) in conjunction with the execution of applications 218 and/or emergency communications application 220.

Output device(s) 210 may be configured to provide output to a user operating computing device 200. Output may include tactile, audio, or visual output generated as part of a user running one or more software applications, such as applications 218 and/or emergency communications application 220. Output device(s) 210 may include a touch-sensitive screen, sound card, a video graphics adapter card, or any other type of device for converting a signal into an appropriate form understandable to humans or machines. Additional examples of an output device(s) 210 may include a speaker, a cathode ray tube (CRT) monitor, a liquid crystal display (LCD), or any other type of device that can provide output to a user. In some examples, output device(s) 210 may be external to computing device 200 and may be operatively coupled to computing device 200 using a standardized communication protocol, such as for example, Universal Serial Bus protocol (USB) or High-Definition Multimedia Interface (HDMI).

In the example illustrated in FIG. 2, computing device 200 includes display 212. In the example where computing device 200 is a mobile device, display 212 may be an integrated touch-screen display. For example, display 212 may be an LCD or organic light emitting diode (OLED) display configured to receive user touch inputs, such as, for example, taps, drags, and pinches, and display appropriate graphics. Thus, display 212 may be considered as a particular type of input and output device of computing device 200. Display 212 may be configured to allow a user to interact with emergency communications application 220, as described in detail below.

Network interface 214 may be configured to enable computing device 200 to communicate with external devices via one or more networks, such as communications network 104. Network interface 214 may be a network interface card, such as an Ethernet card, an optical transceiver, a radio frequency transceiver, or any other type of device that can send and receive information. Network interface 214 may be configured to operate according to one or more of the communication protocols described above with respect to communications network 104. In one example, network interface 214 may enable a user of a computing device running emergency communications application 220 to transmit data to and receive data from emergency service site 110.

Operating system 216 may be configured facilitate the interaction of applications, such as application 218 and emergency communications application 220, with processor(s) 202, memory 204, storage device 206, input device(s) 208, output device(s) 210, display 212, network interface 214 and other hardware components of computing device 200. Operating system 216 may be an operating system designed to be installed on laptops and desktops. For example, operating system 216 may be a Windows operating system, Linux, or Mac OS. In another example, if computing device 200 is a mobile device, such as a smartphone or a tablet, operating system 216 may be one of Android, iOS, or a Windows mobile operating system.

Applications 218 may be any applications implemented within or executed by computing device 200 and may be implemented or contained within, operable by, executed by, and/or be operatively/communicatively coupled to components of computing device 200, e.g., processor(s) 202, memory 204, and network interface 214. Applications 218 may include instructions that may cause processor(s) 202 of computing device 200 to perform particular functions. Applications 218 may include algorithms which are expressed in computer programming statements, such as, for loops, while-loops, if-statements, do-loops, etc.

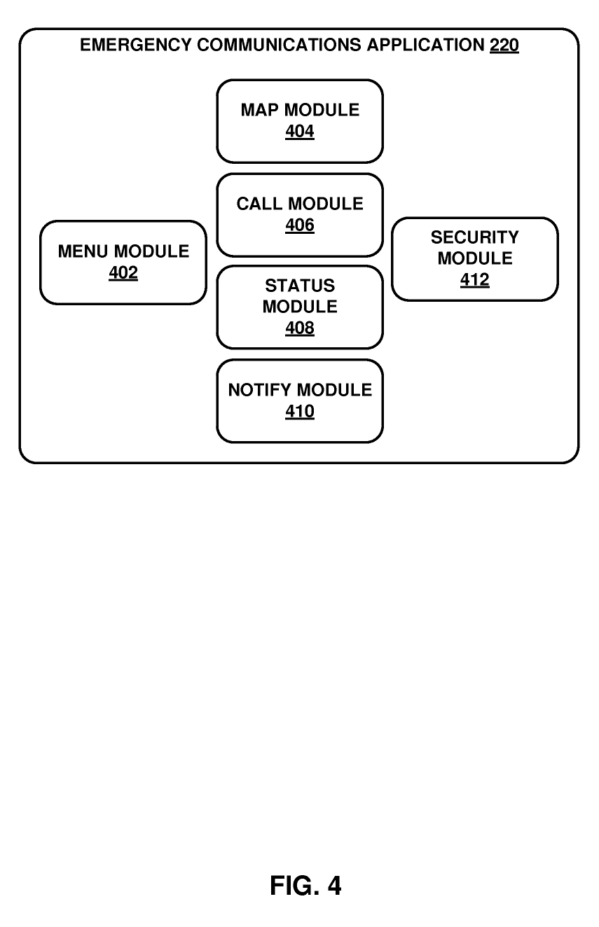

Emergency communications application 220 may be an application that enables computing device 200 to perform functionality associated with system 100. In one example, emergency communications application 220 may be a web browser, such as, for example, Internet Explorer of Google Chrome and any associated supporting software modules (e.g., plugins). In one example, where computing device 200 is a mobile device (e.g., a smart phone or a tablet computing device), emergency communications application 220 may be a dedicated application designed for a mobile operating system. In one example, system 100 may include multiple versions of emergency communications application. For example, emergency communications application 220 may include a regular version for civilian users and an enhanced version for users who may wish to aid others in the event of an emergency. Emergency communications application 220 is described in greater detail below with respect to FIG. 4.

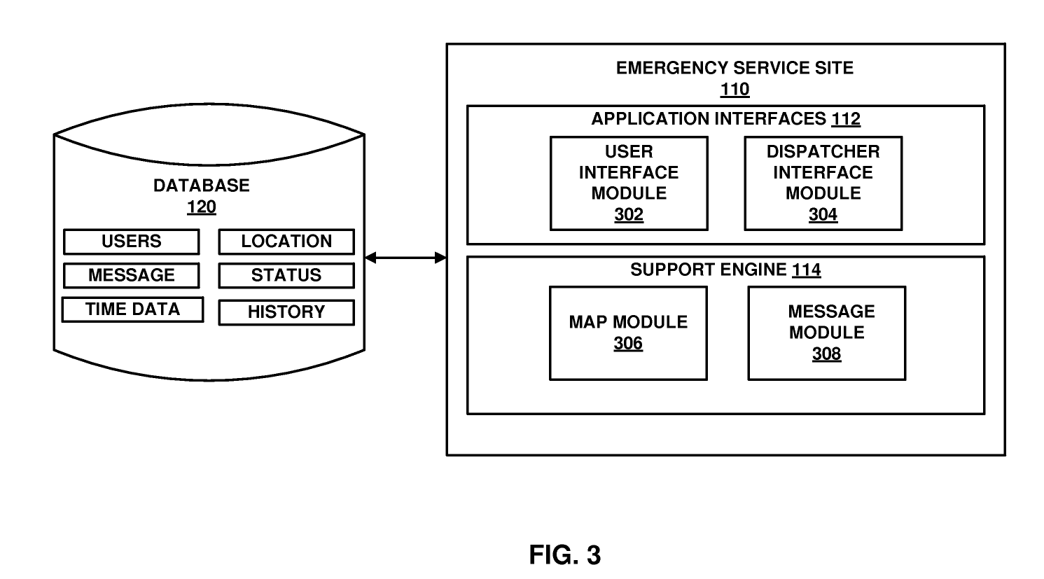

FIG. 3 is a block diagram illustrating a detailed view of an example system that may implement one or more techniques of this disclosure. As illustrated in FIG. 3, application interface 112 includes user interface module 302 and dispatcher interface module 304. Support engine 114 includes map module 306 and message module 308. Application interfaces 112, support engine 114, and modules thereof may be implemented as any of a variety of suitable circuitry, such as, one or more microprocessors, digital signal processors (DSPs), application specific integrated circuits (ASICs), field programmable gate arrays (FPGAs), discrete logic, software, software modules, hardware, firmware or any combinations thereof.

In one example, application interfaces 112, support engine 114, and modules thereof may be implemented using one or more programming languages. Examples of programming languages include Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, Python, UNIX Shell, Visual Basic or Visual Basic Script, Virtual Reality Markup Language (VRML), ColdFusion™ and other compilers, assemblers, and interpreters.

As described above, database 120 may store information associated with the operation of emergency service site 110. As illustrated in FIG. 3, database 120 may include the following example types of data: user data, location data, message data, status data, time data, and history data. User data may include data associated with a computing device connected to network 104 and users thereof. In one example, user data may include a user name, a mobile telephone number, and an IMEI number (i.e., International Mobile Station Equipment Identity). Further, in one example, user data may include data indicating whether a user is a civilian or whether a user is an individual that wishes to provide aid during an emergency situation. In one example, an individual that can provide aid during an emergency situation may be referred to as a responder and may include a doctor, a nurse, fire personnel, or a law enforcement officer. As described above, a version of emergency communications application 220 may be based on whether the user is a civilian or a responder. As described in detail below, emergency service site 110 may be configured to provide different types of information to a user based on whether a user is a citizen or a responder.

Location data may include data associated with the location of a computing device connected to network 104. In one example, location data may include latitude and longitude coordinates. In one example, in the case where a computing device is a mobile device, location data may be generated using a global position system (GPS). In one example, message data may include messages generated by users of a computing device and/or messages generated by emergency service site 110. As described in detail below, messages generated by users may include messages including multimedia generated by users at the site of an emergency situation. Further, messages generated by users may include messages intended for other users and/or messages intended for emergency service personnel. Emergency service site 110 may process received messages in order to coordinate emergency responses. Further, as described in detail below, messages generated by emergency service site 110 may include detailed messages generated by emergency personnel and may be selectively transmitted to one or more users of computing devices 102A-102N. In one example, status data may include data associated the status of users of computing devices 102A-102N. In one example, possible statuses of users may include Unknown, Needs Help, Okay, and/or Able to Help. Time data may include time information associated with one or more of location data, message data, and status data. For example, time data may include timestamps associated with a received message, location, and/or status. As described in detail below, time data may be used by emergency service site 110 to coordinate an emergency response.

In one example, history data may include data associated with a past emergency situation. For example, history data may include a 911 call volume associated with a past emergency situation and/or logs of location data of computing devices associated with a past emergency situation during stages of the past emergency data. History data associated with a past emergency situation may be organized based on one or more of: a location or geographic information (e.g., urban area, mountains, flood zone, etc.). In this manner, emergency service site 110 may compare historic data associated with a past emergency situation to data received during a current emergency situation to predict unknown information associated with a current emergency situation. For example, emergency services site 110 may determine that the source of a current emergency situation is an explosion based on one or more of a current call volume, current location data, and geographic information matching a call volume, logs of location data, and geographic information of a past emergency situation. For example, a high call volume, movement from a center location, and an urban area location may predict an explosion. Emergency service site 110 may use historic data to coordinate an emergency response.

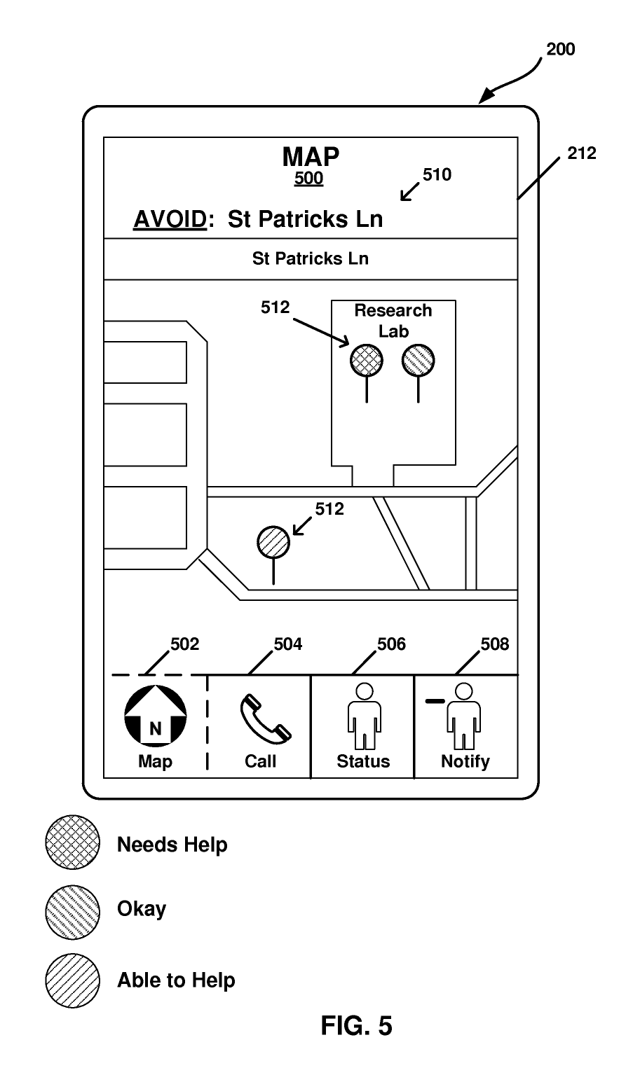

As described above, application interface 112 may provide one or more graphical user interfaces to computing devices 102A-102N and users of a computing device may use the graphical user interfaces to communicate with emergency service site 110. User interface module 302 may be configured to provide graphical user interfaces to a computing device. In one example, user interface module 302 may be configured to provide the graphical user interfaces described with respect to FIGS. 5-9 to one or more of computing devices 102A-102N. As described in detail below, information provided in a graphical user interface may differ based on whether a user is a civilian or a responder.

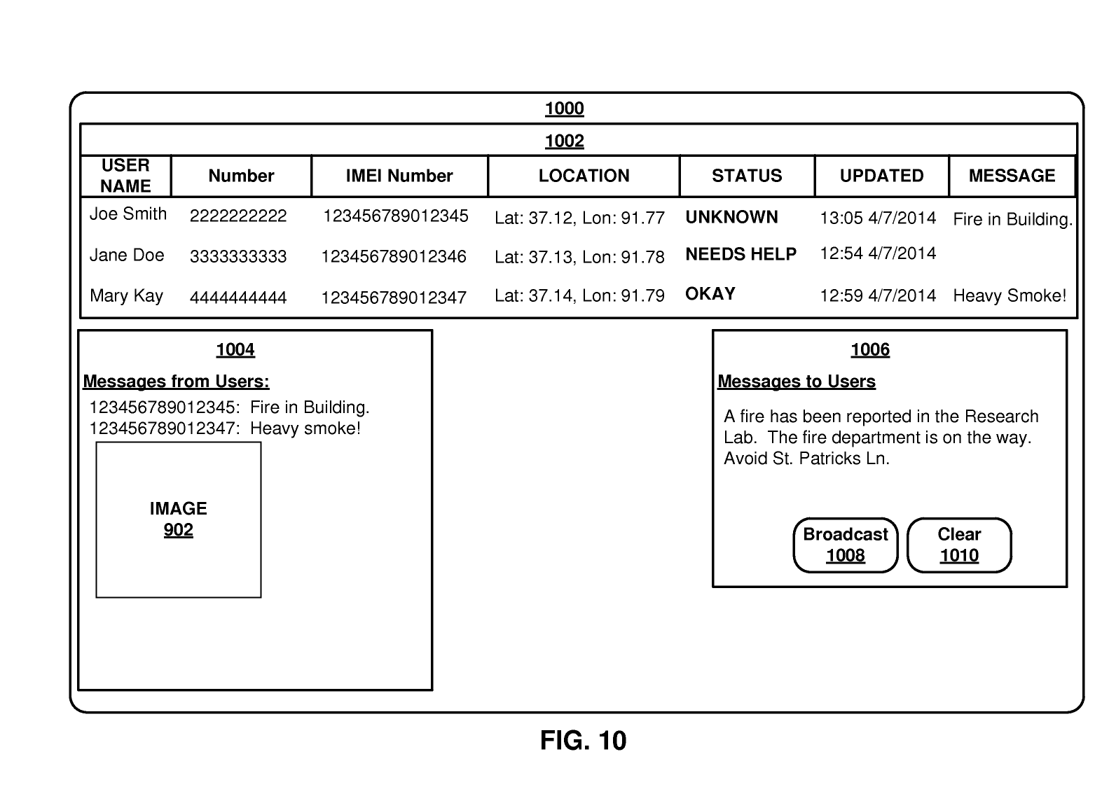

As described above, emergency service site 110 may be a server located at a local police department, a local fire department, an emergency medical service site, a central emergency response site, or a local office of a nation emergency response site. Dispatcher interface module 304 may be configured to provide one or more graphical user interfaces to an emergency dispatcher. For example, dispatcher interface module 304 may be configured to provide a graphical user interface to a fire department dispatcher and the graphical user interface may enable a fire department dispatcher to communicate with one or more of civilians, responders, and/or emergency personnel. It should be noted that in some examples a dispatcher may be in the same physical location as emergency service site 110 and in other examples a dispatcher may be located at a distinct physical location from emergency service site 110 and may access emergency service site 110 using a computing device, such as, for example, one of computing devices 102A-102N. In one example, emergency service site 110 may be located at a central location within a municipality and each of plurality of dispatchers (e.g., fire, police, and EMS) may access emergency service site 110 using a computing device. In one example, dispatcher interface module 304 may be configured to provide one or more of the graphical user interfaces described with respect to FIGS. 10-12.

As described above, database 120 may include user data, location data, message data, status data, time data, and history data. Map module 306 may be configured to receive one or more of user data, location data, message data, status data, time data, and history data and provide mapping data. Mapping data may be used by one or more of emergency communications application 220, user interface module 302, and/or dispatcher interface module 304 to generate a graphical user interface including a map. In one example, a graphical user interface including a map may include a real-time map of a location of an emergency situation. A map may display user locations and statuses. In one example, a map may update as users move and as statuses change.

As described in detail below with respect to FIG. 5, a map may enable a civilian to navigate away from danger and/or to navigate to other users. Further, a map may enable a responder to provide assistance. Types of information included in a map may be based on whether a user is a civilian or a responder. For example, location information associated with other users available to any particular user may vary based on whether a user is a civilian or a responder. For example, if a user is a civilian, the user may be able to see locations of other users on the map with a status of Okay, so that the user can know where there is congestion and/or where a safe area is located. Further, in this example, if a user is a responder, then the user may additionally be able to see both users with a status of Injured and Okay. As described in detail below with respect to FIG. 5, users with a status of Injured may be distinguished from users with a status of Okay (e.g., color codes may be used to identify statuses). A user may be provided with a graphical user interface that enables the user to set a status.

In addition to using mapping data to provide a graphical user interface including a map to civilians and responders, mapping data may be used to provide a graphical user interface including a map to dispatchers and/or emergency service personnel. In one example, dispatcher interface module 304 may provide a graphical user interface including a map with increased functionality. For example, whereas a map provided to a user may include only information within the user's proximity, a map provided to a dispatcher may be a full map of an area and a graphical user interface may enable a dispatcher to create zones within a map. For example, a dispatcher may be able to “draw” safe zones and dangerous zones on a map. In one example, an algorithm may be used to approximate the center of an emergency situation based on received location and status data and/or history data. A dispatcher may be able to confirm the disaster area and/or increase or decrease a disaster area. In one example, areas designated by a dispatcher may be viewable on maps provided to users. For example, dangerous areas may appear as orange on a map provided to a user and safe zones may appear as green.

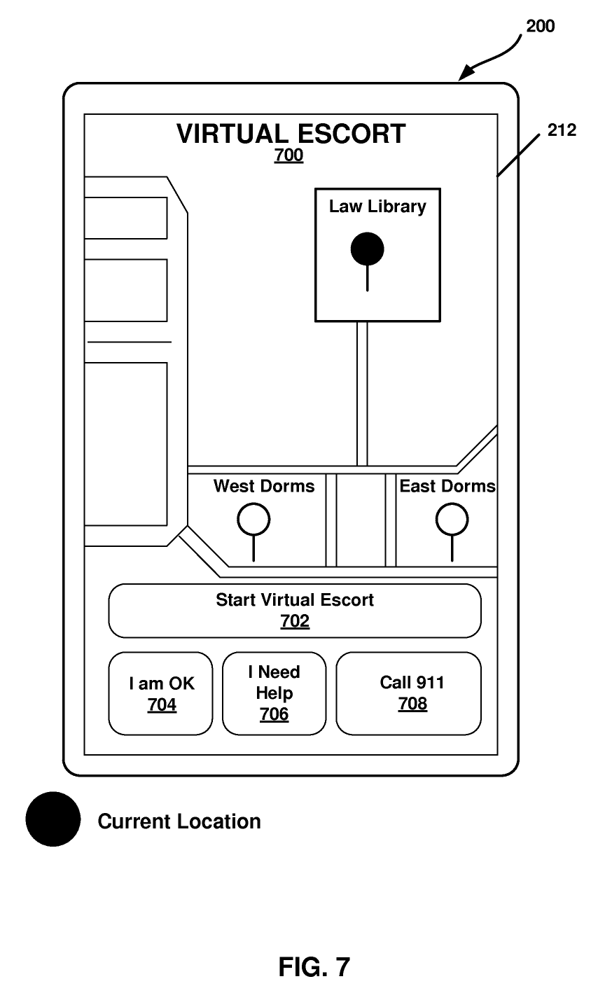

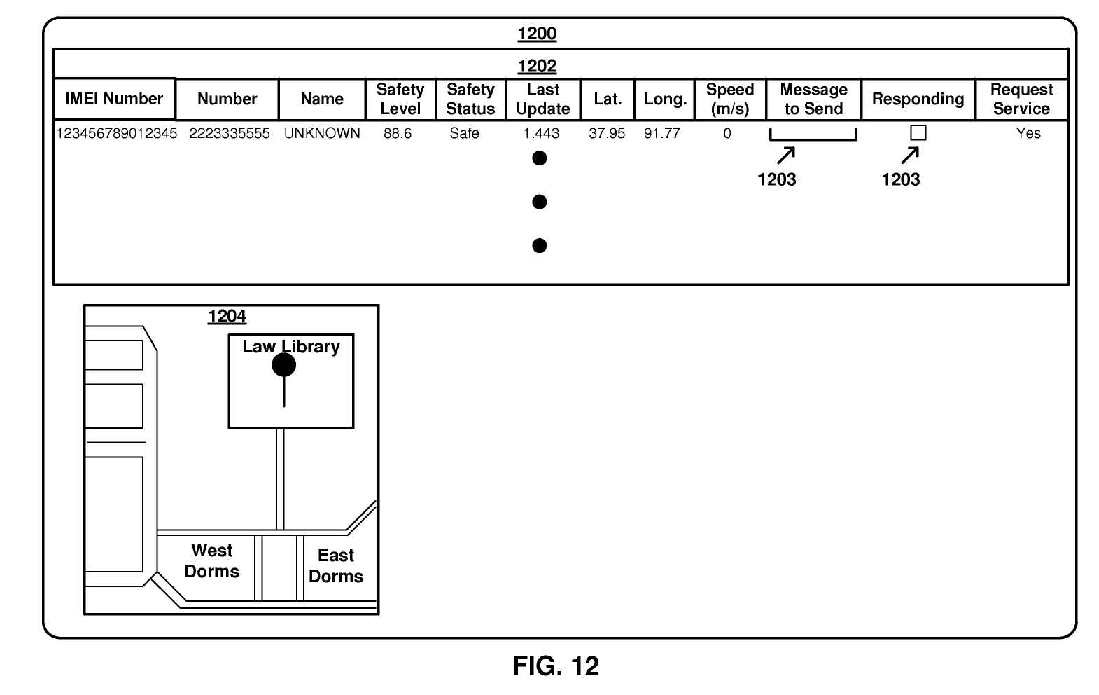

It should be noted that although map module 306 is described in the example above with respect to emergency situations, in some examples map module 306 may be used by emergency service personnel in other situations. In one example, map module 306 may enable emergency service personnel to provide a virtual escort for a user. For example, in the case where emergency service personnel includes campus police and a user is a student. A student may be able to use emergency communications application 220 to request a virtual escort. In this example, a campus police officer may be provided with a graphical user interface including a map that enables the campus police officer to track the status and location of the student on a campus map. For example, if the student is walking home late at night, the campus police officer may be able to track whether the student arrives safely (i.e., no change in status while traveling a correct route). During a virtual escort, emergency service personnel and a user may be able to message one another to provide/request updates. Examples of graphical user interfaces used to provide a virtual escort are described in detail below with respect to FIG. 7 and FIG. 12.

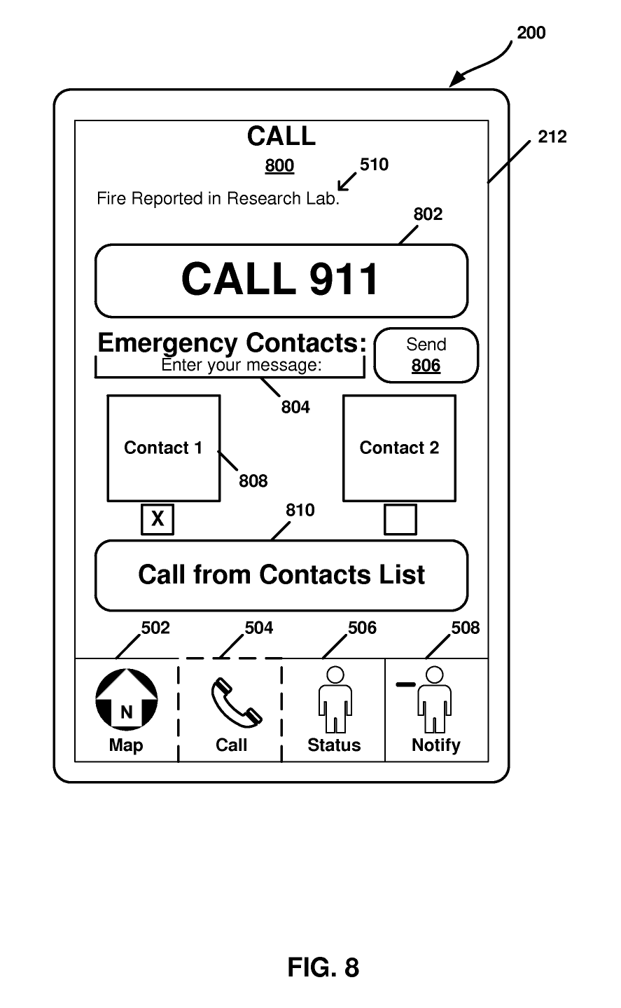

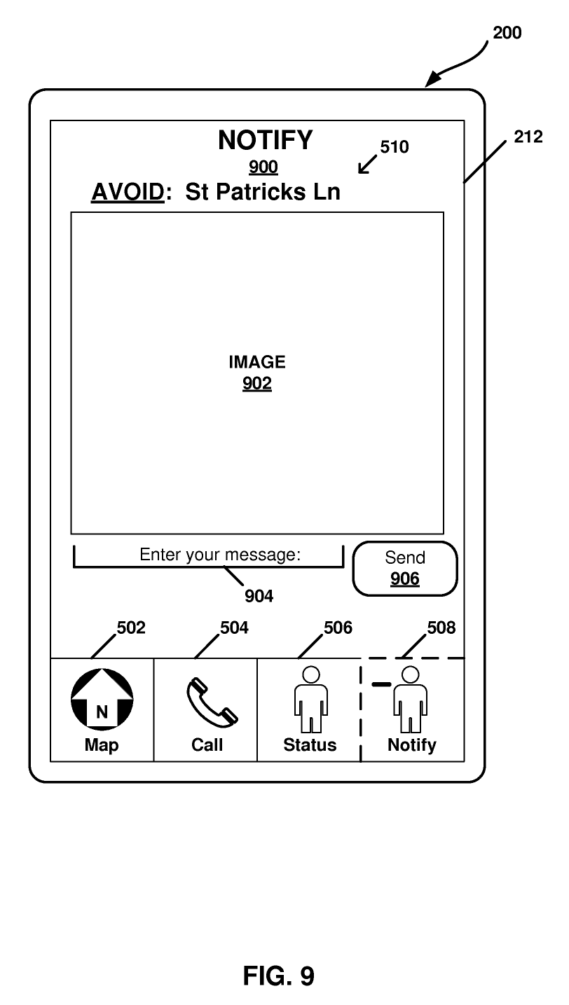

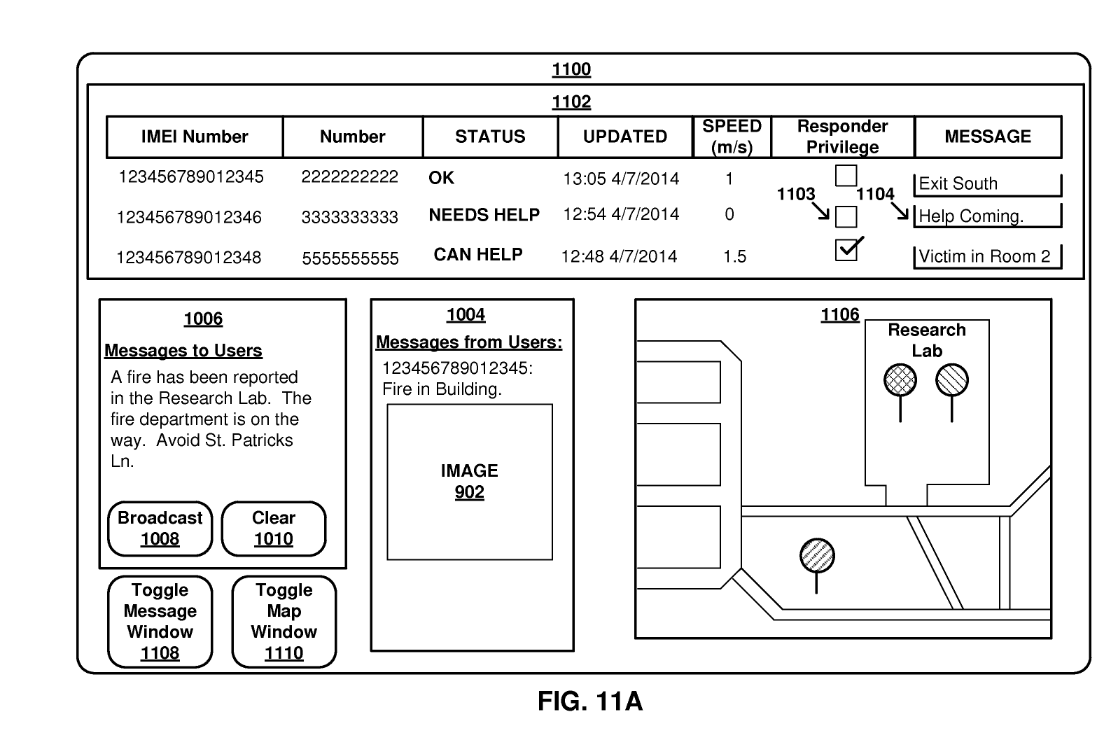

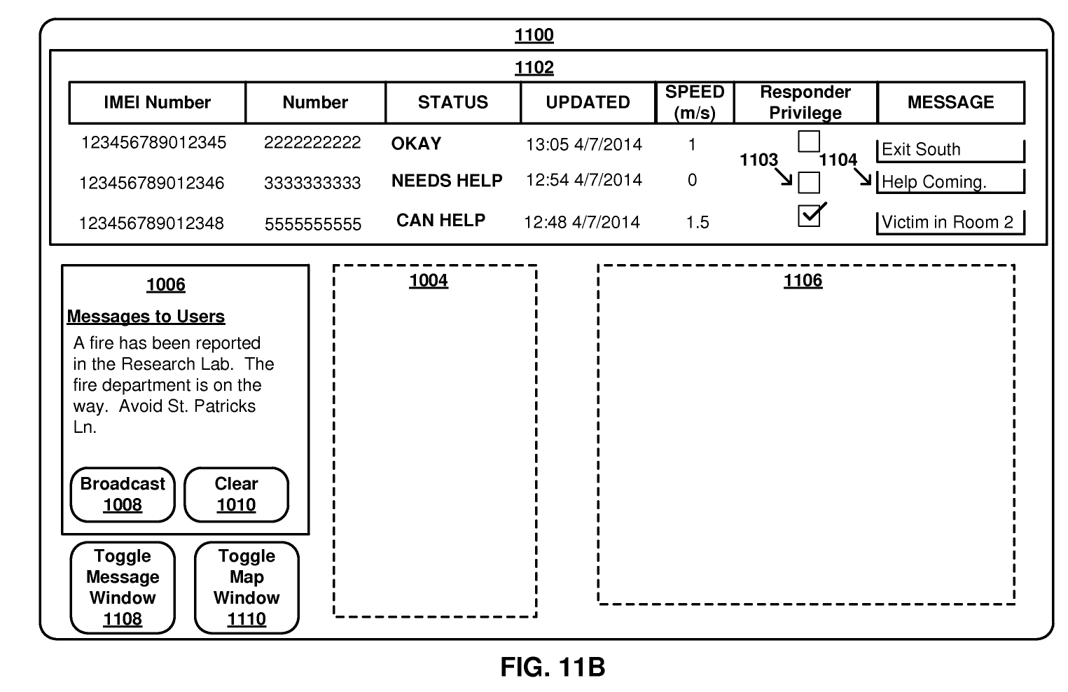

As described above, message data may include messages generated by users of a computing device and/or messages generated by emergency service site 110. Messages generated by users of a computing device are described in more detail below with respect to FIGS. 8 and 9. Message module 308 may be configured to receive messages generated from users of a computing device and route messages to emergency service personnel. Information included in messages generated by users may be used to inform responders of hazards prior to arrival at the scene of an emergency situation and alert those near the hazard. In one example, dispatcher interface module 304 may be configured to provide a graphical user interface including messages from users. FIGS. 10-11B illustrate examples of graphical user interfaces including messages from users.

As described above, user interface module 302 may be configured to provide graphical user interfaces to a computing device. In one example, user interface module 302 may be configured to provide graphical user interfaces including messages from emergency service site 110. For example, a dispatcher may wish to broadcast a message about an emergency situation to users. As described above with respect to map module 306, information provided in a graphical user interface may differ based on whether a user is a civilian or a responder. Message module 308 and/or user interface module 302 may be configured to provide distinct messages to users based on whether a user is a civilian or a responder, location information, and/or status information. In one example, the level of detail and types of information included in a message may differ based on whether a user is a civilian or a responder. For example, responders may receive messages including much more information about an emergency situation. Message module 308 may be configured to generate several different types of messages. In one example, message module 308 may be configured to generate one or more of banner messages, text messages (e.g., Short Message Service (SMS messages), and/or email messages.

In one example, a banner message may include a message that appears in a graphical user interface provided to a set of users, where a set of users may be defined based on one or more of whether a user is a civilian or a responder, location information, and/or status information. In one example, the information included in the banner message may be dynamically provided by emergency service personnel and emergency service personnel may be able to define sets of users. An example of a graphical user interface that enables emergency personnel to dynamically provide messages is described with respect to FIGS. 10-11B.

A banner message may include information that is applicable to all users within a set. For example, a banner message may indicate best paths to exit the scene of an emergency situation (e.g., instructions on how to avoid congested areas). Further, a banner message may inform users of safety precautions or guide users through a safe procedure (e.g., “Heavy smoke in the area. Stay Low. Avoid elevators.”). In one example, message module 308 may be configured to change a banner message provided to a user based on whether a user is removed from or added to a set (e.g., a user's status changes). For example, as described above, emergency personnel may define dangerous zones and safe zones, information included in a banner message may change if a user moves from a dangerous zone to a safe zone. Further, in one example, a banner message may constantly be displayed to a user during the operation of emergency communications application 220, so that a user is always provided with the most current information regarding an emergency situation. In this manner, emergency service site 110 is configured to provide information to users of computing devices 102A-102N during an emergency situation.

As described above, emergency communications application 220 is an example of an application configured to enable a computing device to perform functionality associated with system 100. For example, emergency communications application 220 may be configured to enable communications between a computing device and emergency service site 110 in order to provide users information according to the techniques described herein. FIG. 4 is a conceptual diagram illustrating an example of an emergency communications application 220. As illustrated in FIG. 4, emergency communications application 220 includes menu module 402, map module 404, call module 406, status module 408, notify module 410, and security module 412. Modules illustrated in FIG. 4 may be software modules and/or may be implemented using any combination of hardware, software, or firmware. In one example, modules illustrated in FIG. 4 may be software stored locally on computing device 200 (e.g., modules may be stored on memory 204 and/or storage device 206). In other examples, the modules illustrated in FIG. 4 may be software modules and/or portions thereof may be distributed throughout system 100.

As described above, there may be multiple versions of emergency communications application 220. In one example, emergency communications application 220 may include a regular version for civilian users and an enhanced version for responders. In one example, an enhanced version of emergency communications application 220 may enable users to have the option to register their phones (e.g., IMEI number) with the emergency service site 110 when they first install emergency communications application 220 and provide credentials (e.g., indicate that they are a nurse) to request an enhanced version of emergency communications application 220. In one example, emergency service site 110 may be configured to verify credentials and approve or reject requests. For users that are approved, security module 412 may send a special unique code to the user's computing device as a secure message, and when such users enter the code in the emergency communications application 220, enhanced functionality may be enabled. In one example, emergency communications application 220 may include a tutorial to assist users in learning the functionality of emergency communications application 220.

Referring again to FIG. 4, menu module 402 may be configured to allow a user of emergency communications application 220 to select one of a plurality functions associated with the operation of emergency communications application 220. FIGS. 5-9 are examples of graphical user interfaces that may be provided by a computing device to implement one or more techniques of this disclosure. It should be noted that the examples illustrated in FIGS. 5, 6, 8, and 9 are described with respect to an example emergency situation where a fire is occurring in a research lab located on a university campus. Map icon 502, call icon 504, status icon 506, and notify icon 508 illustrated in FIGS. 5, 6, 8, and 9 represent examples of graphical user interface components that may be provided in conjunction with functions associated with menu module 402.

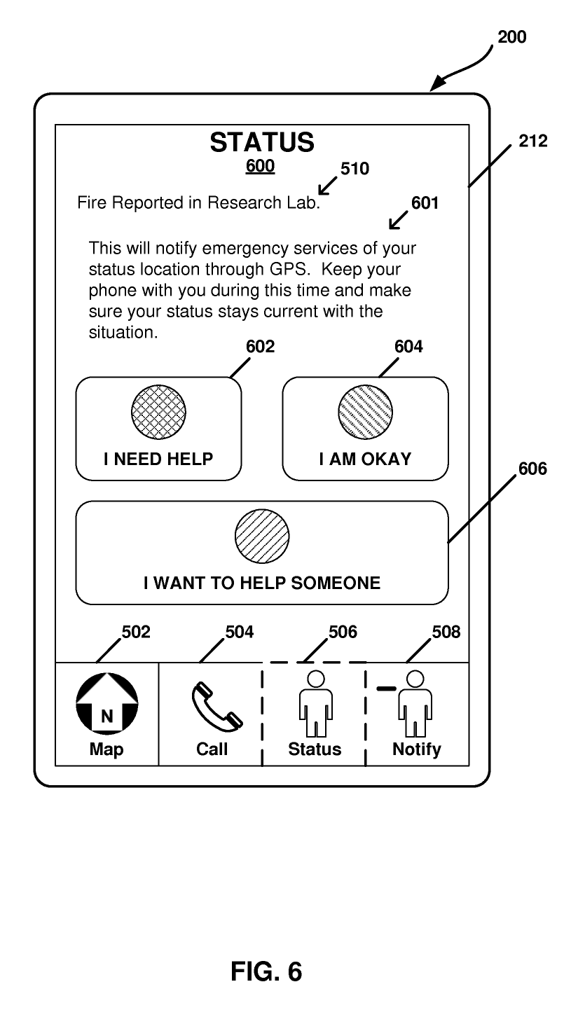

A user of a computing device may select one of map icon 502, call icon 504, status icon 506, and notify icon 508 using an input device, such as, for example, input device(s) 208 (e.g., tapping a touch-sensitive display). Upon selection of one of map icon 502, call icon 504, status icon 506, and notify icon 508 by a user, a computing device may respectively provide one of: map graphical user interface 500 illustrated in FIG. 5, call graphical user interface 800 illustrated in FIG. 8, status graphical user interface 600 illustrated in FIG. 6, or notify graphical user interface 900 illustrated in FIG. 9.

Map module 404 may be configured to generate a graphical user interface including a map. As described above, emergency service site 110 may provide mapping information to a computing device. Map module 404 may process mapping information and generate a graphical user interface including a map. Graphical user interface 500 illustrated in FIG. 5 is an example of a graphical user interface including a map. As illustrated in FIG. 5, graphical user interface 500 includes a map of an area including a banner message 510 and user locators 512. In one example, a map may be a GPS-based map that updates as a user changes location. A user may use a map to orient themselves to their surroundings and locate areas known to be either safe or hazardous during the emergency. Banner message 510 may include a banner message generated by message module 308, as described above. In the example illustrated in FIG. 5, banner message 510 provides instructions for avoiding congestion. Further, as described above, although not shown in FIG. 5, in some examples, a map may include dangerous areas and safe areas. Thus, graphical user interface 500 may enable a user to navigate away from dangerous and/or congested areas.

As described above, in one example, possible statuses of users may include Unknown, Needs Help, Okay, and/or Able to Help. Each of user locators 512 identify a user's location on a map and include user status information. In the example illustrated in FIG. 5, a user with a Needs Help status is located in Research Lab, a user with an Okay status is located in Research Lab, and a user with an Able to Help status is located outside of Research Lab. A user viewing graphical user interface 500 may be able to response to and recover from an emergency situation based on information included in the map. For example, if a user viewing the map is hurt, the user may navigate to the location of the user with an Able to Help status. Further, if a user viewing the map is a responder, the responder may navigate to the location of the user with a Needs Help status.

In one example, any user may be able to see locations of all responders. This may be important in some types of emergency situations. For example, in a shooter situation, if a user is hiding and needs help and someone knocks on a door, a user may not know whether or not it is safe to open the door. If the user sees a user locator with an Able to Help status in the vicinity of the door, the user will have a degree of confidence that the person at the door is a responder. In this manner, graphical user interface 500 represents an example of a graphical interface configured to enable a user to navigate away from danger and/or to navigate to other users.

As described above, a user may be provided with a graphical user interface that enables the user to set a status. Status module 406 may be configured to generate a graphical user interface enabling a user to set a status. Status module 406 may be configured to transmit status data to emergency communications site 110. Graphical user interface 600 illustrated in FIG. 6 is an example of a graphical user interface that may enable a user to set a status. As illustrated in FIG. 6, graphical user interface 600 includes banner message 510, instructions for setting a status 601, Needs Help status icon 602, Okay status icon 604, and Able to Help status icon 606. Upon activation, each of Needs Help status icon 602, Okay status icon 604, and Able to Help status icon 606 will respectively set a user's status to one of Needs Help, Okay, or Able to Help.

It should be noted that in some examples, prior to setting a status a user may be assigned a default status. For example, a civilian user may be assigned an Unknown status and a responder may be assigned a Can Help status. It should be noted that in some examples, Able to Help status icon may only be enabled for responders. In this manner, an injured user may avoid trying to navigate to an untrained civilian for assistance. Further, in one example responders can also set their status. This may enable a dispatcher to track efforts in aid. For example, a dispatcher may be able to determine if a responder becomes trapped and/or injured.

As described above, in one example, a user may be able to use emergency communications application 220 to request a virtual escort. Map module 404 and status module 406 may be configured to generate a graphical user interface enabling a user to use a virtual escort. Graphical user interface 700 illustrated in FIG. 7 is an example of a graphical user interface that enables a user to navigate to a destination and provide status updates to emergency service personnel. As illustrated in FIG. 7, graphical user interface 700 includes a map showing a user's current location and landmarks, Start Virtual Escort icon 702, I am OK icon 704, I Need Help icon 706, and call 911 icon 708. The map illustrated in FIG. 7 may be similar to the map described above with respect to FIG. 5. In the example illustrated in FIG. 7, a user is located in the Law Library and may wish to navigate to the West Dorms.

Upon a user activating Start Virtual Escort icon 702, emergency service personnel may be provided with a graphical user interface including a map that enables emergency service personnel to track the location and status of the user. In one example, a user may provide a destination to emergency service personnel, for example, by tapping a destination on the map. I am OK icon 704 and I Need Help icon 706 may be similar to status icons described above with respect to FIG. 6. Upon activation, each of I am OK icon 704 and I Need Help icon 706 may enable a user to provide the corresponding status to emergency service personnel. Upon receiving a particular status and/or location, emergency service personnel may respond accordingly. For example, upon receiving an I need Help Status, emergency personnel may dispatch an officer to the location of the user. Further, upon receiving a location that is “off course,” emergency personnel may dispatch an officer to the location of the user. Upon activation of Call 911 icon, computing device 200 may call 911. Thus, graphical user interface 700 may enable a user to avoid dangerous situations that may occur when navigating to a particular area. An example of a graphical user interface that enables emergency personnel to provide a virtual escort is described with respect to FIG. 12.

As described above, messages generated by users may include messages intended for other users and/or messages intended for emergency service personnel. Call module 408 may be configured to generate a graphical user interface enabling a user to call 911, call an emergency contact, and/or send a message to one or more emergency contacts. Graphical user interface 800 illustrated in FIG. 8 is an example of a graphical user interface that may enable a user to call emergency personnel and/or personal contacts. As illustrated in FIG. 8, graphical user interface 800 includes message banner 510, call 911 icon 802, message entry field 804, send icon 806, contact selection entry field 808, and call from contacts list icon 810. Banner message 510 may include information as described above with respect to message module 308. It should be noted that the information included the banner message illustrated in FIG. 8 is distinct from the banner message illustrated in FIG. 5. That is, a banner message included in map graphical user interface 500 includes navigation instructions and a banner message included in call graphical user interface 800 provides general details about an emergency situation.

Upon activation of call 911 icon 802, a user's computing device may call a 911 service. Further, upon activation of call from contacts list icon 810, a user's computing device may call an emergency contact or enable the use to select one of set of designated emergency contacts to call. In this manner, call module 408 may enable a user to quickly call emergency personnel and emergency contacts. Message entry field 804 may be configured to enable a user to enter a message (e.g., “Trapped in Research Lab, but okay”). Further, contact selection entry field 808 may enable a user to select one or more contacts to send a message to. Upon a user activating send icon 806, a message may be sent to selected contacts. In this manner, call module 408 may enable a user to send a text message to a plurality of emergency contacts at the same time. In one example, a user may have an option to choose up to five other users from their contacts list. Further, in one example, a message may also notify selected contacts of the user's location and/or status as an appendix to the message. In one example, if a selected contact is a user of system 100, the user's location may be displayed on another user's map as a distinct status (e.g., a purple dot). Thus, call module 408 enables a user to contact personal contacts and emergency personnel in several ways. It should be noted that in some examples call module 408 may enable silent communication, which may be beneficial is certain emergency situations (e.g., a shooter situation).

As described above, messages generated by users may include multimedia messages including multimedia generated at the site of an emergency situation intended for emergency service personnel. Notification module 410 may be configured to generate a graphical user interface enabling a user to send a multimedia message to emergency service site 110. Graphical user interface 900 illustrated in FIG. 9 is an example of a graphical user interface that may enable a user to send a multimedia message to emergency service site 110. As illustrated in FIG. 9, graphical user interface 900 includes message banner 510, image 902, message entry field 904, and send icon 906. Message banner 510 may be similar to message banners described above with respect to FIG. 5 and FIG. 8.

Image 902 may include an image that a user obtained using an input device of a computing device, such as, for example, input device(s) 208 (e.g., a camera of a smart phone). Message entry field 904 may be similar to message entry field 804 described above and may be configured to enable a user to enter a message associated with image 902 (e.g., “Third floor hallway of Research Lab.”). In one example, graphical user interface 900 may enable a user to append an event type category to an image (e.g., robbery, kidnapping, explosion, fire, etc.). Upon a user activating send icon 906, image 902 and any associated messages may be sent to emergency service site 110. In this manner, a user can rapidly take one or more images of the incident on a camera and the image may be quickly uploaded to emergency service site 110. As described above, an input device of a computing device may include a microphone. In one example, graphical user interface 900 may enable a user to send messages including recorded sounds to emergency service site 110. In some instances, recorded sounds may be used to determine the type of an emergency situation that is occurring. For example, recorded sounds may enable a dispatcher or a module of emergency service site 110 to identify an event as one of a bomb exploding, or a building collapsing, or to isolate the voice of a kidnapper. Further, recorded sounds may be used to localize where an emergency situation is occurring.

Dispatcher interface module 304 may be configured to provide a graphical user interface that enables a dispatcher to process incoming messages for useful information. A dispatcher may then be able to pass useful information to responders. For example, a dispatcher may be able to send a message to responders to avoid areas of a building based on images taken at an area of a building. Further, information included in message may enable a dispatcher to determine dangerous zones or safe zones, as described above, as well as real-time threat information. By enabling users to send messages to emergency service site, an emergency situation may be handled in a more responsive manner.

As described above, dispatcher interface module 304 may be configured to provide one or more graphical user interfaces that enable a dispatcher to provide messages to users. Graphical user interface 1000 illustrated in FIG. 10 is an example of a graphical user interface that may enable a dispatcher to communicate with users. Further, graphical user interface 1100 illustrated in FIGS. 11A-11B is an example of a graphical user interface that may enable a dispatcher to communicate with users. As illustrated in FIG. 10, graphical user interface 1000 includes user information window 1002, messages from users window 1004, and messages to users window 1006. Further, messages to users window 1006 includes broadcast icon 1008 and clear icon 1010. As described above, user data may include a user name, a mobile telephone number, and an IMEI number, location data may include latitude and longitude data, status data may include Unknown, Needs Help, Okay, and Able to Help. Further, as described above, time data may include timestamp data associated with user communications. User information window 1002 displays a summary of data associated with user of system 100. By providing a summary of data associated with users of system, user information window 1002 may enable a dispatcher to determine how to best respond to an emergency situation.

As described above, dispatcher interface module 304 may be configured to provide a graphical user interface that enables a dispatcher to process incoming messages for useful information. Messages from users window 1004 is an example of a graphical user interface that enables a dispatcher process incoming messages for useful information. In one example, messages from users may be displayed chronologically, by relevance (e.g., keyword sorting), and/or by whether they include multimedia data. As described above, dispatcher interface module 304 may be configured to provide a graphical user interface that enables a dispatcher to dynamically provide messages to a defined sets of users. Messages to users window 1006 is an example of a graphical user interface that enables emergency personnel to dynamically provide messages. In example illustrated in FIG. 10, a dispatcher may enter a message and upon activation of broadcast icon 1008 a message may be sent to a defined set of users. For example, a message may be sent to all users, responders only, and/or civilians only. Upon activation, clear icon 1010 may clear an entered message. In this manner, graphical user interface 1000 represents an example of a graphical user interface that enables communications during an emergency situation.

Referring to FIGS. 11A-11B, in addition to including messages from users window 1004 and messages to users window 1006, described above with respect to FIG. 10, graphical user interface 1100 includes user information window 1102, map window 1106, toggle message window icon 1108, and toggle map window 1110. Toggle message window icon 1108 and toggle map window 1110 may respectively enable a user to cause messages from users window 1004 and map window 1106 to be displayed or not displayed. In some examples, toggle messages window icon 1108 may toggle messages from users window 1104 and/or messages to users window 1006. FIG. 11A illustrates an example where toggle message window icon 1108 and toggle map window 1110 are set such that both messages from users window 1004 and map window 1106 are displayed. FIG. 11B illustrates an example where toggle message window icon 1108 and toggle map window 1110 are set such that neither of messages from users window 1004 or map window 1106 are displayed. In some instances it may be particularly useful for a dispatcher to be able to toggle the display of windows. For example, in the case where an emergency situation causes a dispatcher to become inundated with numerous messages (e.g., dozens, hundreds, or thousands), a dispatcher may wish to hide incoming message in order to focus on sending instructions to one or more responders.

As further illustrated in FIGS. 11A-11B, graphical user interface 1100 includes user information window 1102. User information window 1102 may be similar to user information window 1002 described above. In the example illustrated in FIGS. 11A-11B, in addition to displaying IMEA Number, Number, Status, and update time, as displayed in user information window 1002, user information window 1102 displays a speed associated with a user (i.e., how fast a user's computing device is moving), and includes responder privilege check boxes 1103 and individual user message fields 1104. As described above, types of information included in a map may be based on whether a user is a civilian or a responder and as further described above, the level of detail and types of information included in a message may differ based on whether a user is a civilian or a responder. Thus, a responder may have one or more privileges compared to a civilian user (e.g., access to types of data). Responder privilege check boxes 1103 may enable a user of graphical user interface to determine which users have responder privileges. As described above, in some examples, responder status may be determined by verifying the credentials of an authorized user. In some examples, responder privilege check boxes 1103 may supplement and/or override other techniques for registering a device as a responder device. For example, in an emergency situation where a responder's device has been compromised (e.g., taken by a shooter), it may be useful for a dispatcher to be able to insure sensitive information is not sent to the device.

As described above, a dispatcher may send a message to a defined set of users using messages to user window 1006. In some situations, in addition sending a message to a defined set of users, it may be useful for a dispatcher to be able to send particular messages to particular users. For example, in the case where a single user is in immediate danger and other users are generally safe, a dispatcher may prioritize sending a specific message to the user in immediate danger. Individual user message fields 1104 enables a user of graphical user interface 1100 to send individual messages to respective individual users. In one example, each of individual user message fields may include a text box and user can send a message by entering text in the field. In this manner, graphical user interface 1100 represents an example of a graphical user interface that enables communications during an emergency situation.

As described above, in one example, a user may be able to use emergency communications application 220 to request a virtual escort. Graphical user interface 1200 illustrated in FIG. 12 is an example of a graphical user interface that may enable a dispatcher to communicate with users during a virtual escort. As illustrated in FIG. 12, graphical user interface 1200 includes user information window 1202 and map window 1204. User information window 1202 may be similar to user information window 1002 and user information window 1102 described above. In the example illustrated in FIG. 12, user information window 1202 displays IMEA Number, Number, Name, Safety Level, Safety Status, Last Update, Latitude, Longitude, Speed, and whether a user has requested service. In addition, user information window 1202 includes individual user message fields 1203 and responding check boxes 1205. Each of IMEA Number, Number, Name, Last Update, Latitude, Longitude, and Speed information are described above. A safety level may provide a user's current safety level based on an algorithm. For example, a safety level may be determined on location, time of day and/or crime statistics. A safety status may include a status provided by a user, e.g., using graphical user interface 700 described above. Individual user message fields 1203 may be similar to individual user message fields 1104 described above and may enable emergency services personnel to send a message to a user. Responding check boxes 1205 may enable emergency services personnel to indicate whether a user is responding to communications. In the case where a user is not responding, additional emergency services personnel may be notified and perform appropriate actions. For example, a security officer may go to the user's location. Map window 1204 may be similar to map window 1106 described above and may enable emergency services personnel to track a user. In this manner, graphical user interface 1200 represents an example of a graphical user interface that enables communications during an emergency situation.

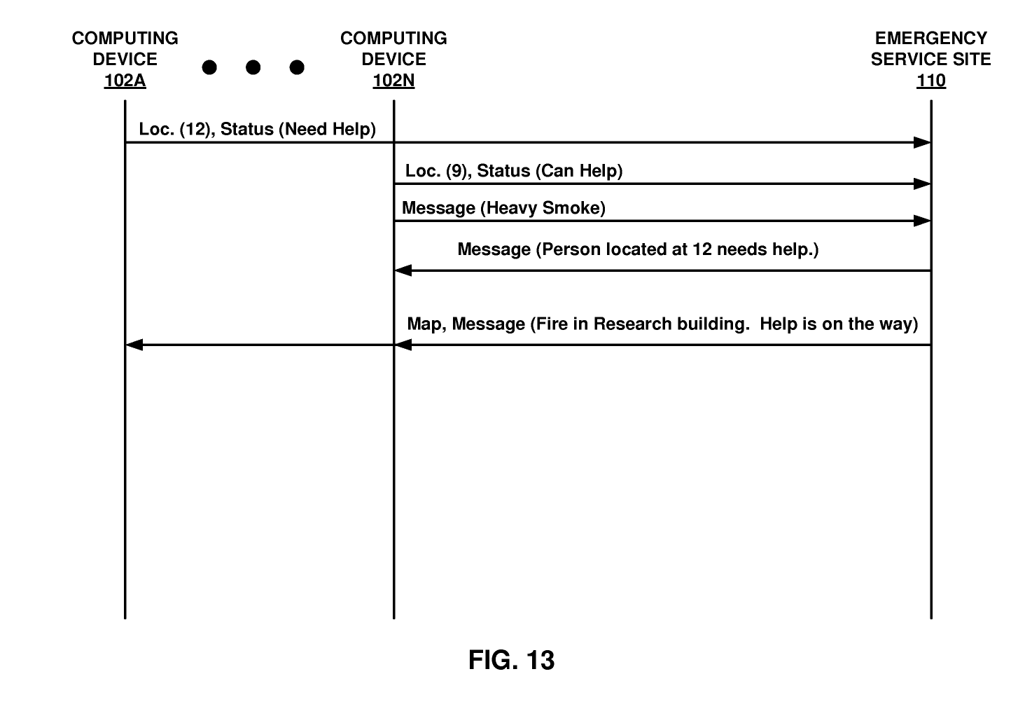

FIG. 13 is a conceptual diagram illustrating one or more techniques of this disclosure. As illustrated in FIG. 13, emergency service site 110 receives location data, status data, and messages from computing devices 102A-102N. Emergency services site 110 send messages and map information to one or more of computing devices 102A-102N. In this manner, system 100 represents an example of a system configured to enable communications during an emergency situation.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for enabling emergency communications, the method comprising:
receiving location data from one or more users;
receiving user status data from the one or more users;
generating map data based on the received location data and the received user status data; and
providing map data to the one or more users, wherein the map data enables a computing device to generate a graphical user interface including a map displaying a location, a status of the one or more users, and one or more areas designated by safety.

2. The method of claim 1, wherein receiving location data from one or more users includes receiving location data from a user's computing device, wherein the location data includes location data determined from a global positioning system.

3. The method of claim 1, wherein receiving user status data from the one or more users includes receiving a user indicated status.

4. The method of claim 1, wherein receiving user status data from the one or more users includes receiving a default status.

5. The method of claim 3, wherein a user status includes one or more of: Unknown, Needs Help, Okay, and Able to Help.

6. The method of claim 1, further comprising sending a message to the one or more users.

7. The method of claim 6, wherein sending a message to the one or more users includes sending a message to a set of users, wherein a set of users is defined by one or more of: user status data, user location data, and user type data.

8. The method of claim 6, wherein sending a message to the one or more users includes sending a message to a set responder users.

9. A device for enabling emergency communications comprises one or more processors configured to:
receive location data from one or more users;
receive user status data from the one or more users; and
provide a graphical user interface including location data of the one or more users and status data of the one or more users.

10. The device of claim 9, wherein the one or more processors are further configured to receive a message from the one or more users, and provide a graphical user interface including the received message and wherein the graphical user interface enables messages to be sent to a defined set of users.

11. The device of claim 10, wherein a set of users is defined by one or more of: user status data, user location data, and user type data.

12. The device of claim 10, wherein a set of users is defined by whether a user is a responder or a civilian.

13. The device of claim 9, wherein the graphical user interface enables a user to create zones within a map.

14. The device of claim 13, wherein enabling a user to create zones within a map includes enabling a user to confirm an approximated dangerous zone.

15. A non-transitory computer-readable storage medium comprises instructions stored thereon that upon execution cause one or more processors of a device to:
receive location data from one or more users;
receive user status data from the one or more users; and
provide a graphical user interface including location data of the one or more users and status data of the one or more users.

16. The non-transitory computer-readable storage medium of claim 15, wherein the instructions further cause one or more processors to receive a multi-media message from the one or more users, and provide a graphical user interface including the received message and wherein the graphical user interface enables messages to be sent to a defined set of users.

17. The non-transitory computer-readable storage medium of claim 15, wherein a set of users is defined by one or more of: user status data, user location data, and user type data.

18. The non-transitory computer-readable storage medium of claim 15, wherein a set of users is defined by whether a user is a responder or a civilian

19. The non-transitory computer-readable storage medium of claim 15, wherein the graphical user interface enables a user to create zones within a map.

20. The non-transitory computer-readable storage medium of claim 19, wherein enabling a user to create zones within a map includes enabling a user to confirm an approximated dangerous zone.
